(19) United States
(12) Patent Application Publication
(10) Pub. No.: US 2010/0158341 A1
(43) Pub. Date: Jun. 24, 2010

(54) System for Automatically Generating a Mask for Digital Subtraction Angiography

(75) Inventor: John Baumgart, Hoffman Estates, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/620,064

(22) Filed: Nov. 17, 2009

Related U.S. Application Data
(60) Provisional application No. 61/138,548, filed on Dec. 18, 2008.

(51) Int. Cl. G06T 7/00

(52) U.S. Cl. 382/132

(57) ABSTRACT

A system automatically generates a mask image. An interface receives a signal from an X-ray imaging device indicating X-ray radiation dosage for performing imaging is substantially stable. An image processor automatically processes data representing multiple temporally sequential individual images of a portion of patient anatomy to identify, a first image comprising an image in the multiple temporally sequential individual images determined in response to the received signal. The image processor identifies a second image substantially exclusive of an indication of presence of a contrast agent successively followed by an image indicating presence of a contrast agent, by comparing a difference between measures representative of luminance content of the second image and the image indicating presence of a contrast agent, with a threshold. The image processor also identifies a set of images comprising the first and second images and any sequential intervening images. An image data processor automatically averages the set of images for use as a mask image.

This is a non-provisional application of provisional application Ser. No. 61/138,548 filed Dec. 18, 2008, by J. Baumgart.

### FIELD OF THE INVENTION

This invention concerns a system for automatically generating a mask image representing background medical image detail for subtraction from an image including vasculature in the presence of a contrast agent to enhance vascular structure.

### BACKGROUND OF THE INVENTION

In post-processing an acquired image to produce a Digital Subtraction Angiography (DSA) image, a user has an option of creating an averaged mask frame, to reduce noise in a subtracted image. Known image processing systems create an averaged mask frame in response to manual interaction during a post-processing operation. However, it is not known at the time of image acquisition how many image frames a user wishes to average. It is also unknown how many image frames there are available for averaging in an acquired image sequence lying between a first viable mask image frame and a time in the sequence associated with introduction of a contrast agent. An automated mask image generation system according to invention principles automatically generates a mask image and addresses deficiencies of known manual systems.

### SUMMARY OF THE INVENTION

A system automatically creates a mask frame comprising an average of more than one image frame, for use in digital subtraction angiography (DSA) sequence generation. A system generates a mask image representing background medical image detail for use in X-ray imaging. An interface receives a signal from an X-ray imaging device indicating X-ray radiation dosage for performing imaging is substantially stable. An image processor automatically processes data representing multiple temporally sequential individual images of a portion of patient anatomy to identify, a first image comprising an image in the multiple temporally sequential individual images determined in response to the received signal. The image processor identifies a second image substantially exclusive of an indication of presence of a contrast agent successively followed by an image indicating presence of a contrast agent, by comparing a difference between measures representative of luminance content of the second image and the image indicating presence of a contrast agent, with a threshold. The image processor also identifies a set of images comprising the first and second images and any sequential intervening images. An image data processor automatically determines data representing an averaged image of the set of images for use as a mask image by employing an averaging function to average data representing multiple images of the set of images.

### BRIEF DESCRIPTION OF THE DRAWING

FIG. 1 shows a system for generating a mask image representing background medical image detail for use in X-ray imaging, according to invention principles.

FIG. 2 illustrates an image sequence used for mask determination and generating a DSA image sequence.

FIG. 3 shows a system for processing image data to provide an averaged mask built with recursive averaging and motion correction, according to invention principles

FIG. 4 shows a flowchart of a process used by a system for generating a mask image representing background medical image detail for use in X-ray imaging, according to invention principles.

### DETAILED DESCRIPTION OF THE INVENTION

A system automatically generates a mask frame comprising an average of more than one frame, for use in deriving a digital subtraction angiography (DSA) image sequence. An automated mask image generation system according to invention principles automatically determines a first viable mask frame, during angiogram acquisition and analyzes subsequent image frames before beginning review, to determine which frame contains a first trace of contrast agent. The set of image frames that precedes the first frame containing contrast agent comprise frames available for averaging. In response to identifying this set of frames, an averaged frame is generated enabling a DSA sequence to be generated and reviewed.

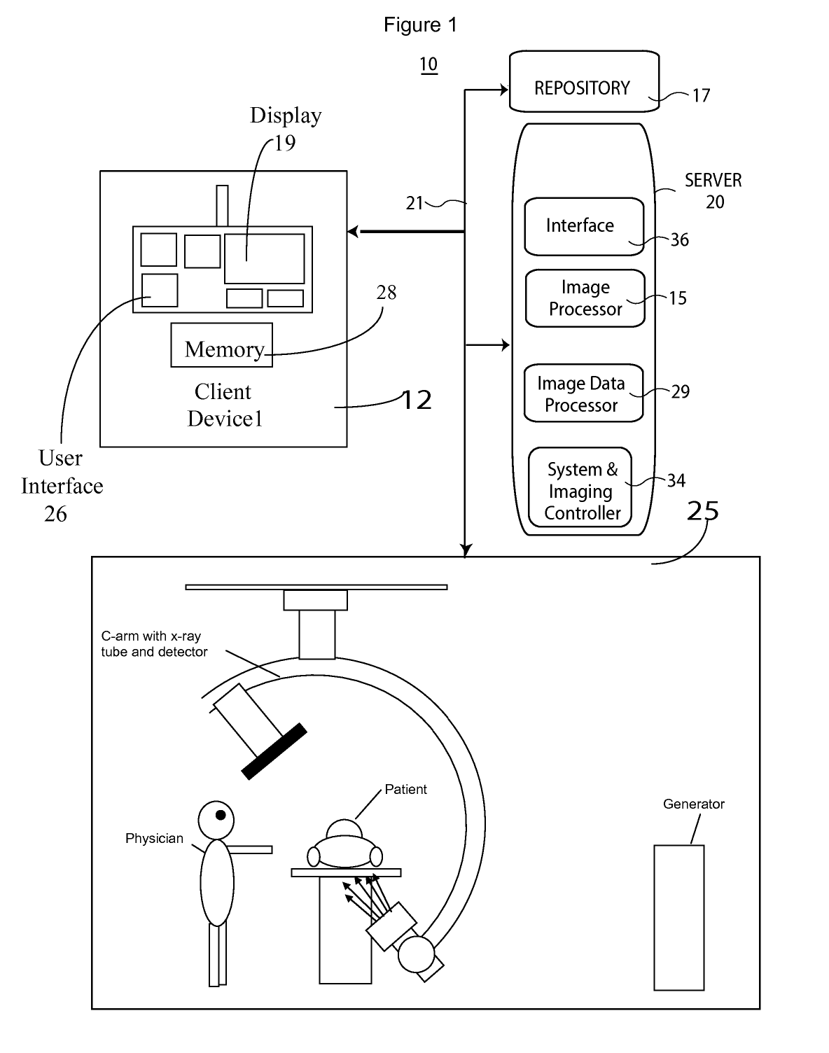

FIG. 1 shows system 10 for generating a mask image representing background medical image detail for use in X-ray imaging. System 10 includes one or more processing devices (e.g., workstations or portable devices such as notebooks, Personal Digital Assistants, phones) 12 that individually include a user interface 26 supporting image presentation in response to predetermined user (e.g., physician) specific preferences and memory 28. System 10 also includes at least one repository 17, X-ray imaging modality system 25 (which in an alternative embodiment may comprise an MR (magnetic resonance), CT scan, or Ultra-sound system, for example) and server 20 intercommunicating via network 21. User interface 26 provides data representing display images comprising a Graphical User Interface (GUI) for presentation on processing device 12. At least one repository 17 stores medical image studies for multiple patients in DICOM compatible (or other) data format. A medical image study individually includes multiple image series of a patient anatomical portion which in turn individually include multiple images. Server 20 includes image processor 19 and system and imaging controller 34. Imaging controller 34 controls operation of imaging device 25 in response to user commands entered via user interface 26.

The image data subtraction system is suitable for use in Angiography (catheterization and stent manipulation) or other medical procedure to enhance vessel visualization. Imaging system 10 acquires, during a medical procedure, data representing multiple temporally sequential individual images of vessels of a portion of patient anatomy using X-ray modality system (imaging device) 25. X-ray modality system 25 comprises a C-arm X-ray radiation source and detector device rotating about a patient table and an associated electrical generator for providing electrical power for the X-ray radiation system. The sequential individual images encompass introduction of a contrast agent (or interventional device). Interface 36 receives a signal from X-ray imaging device 25 indicating X-ray radiation dosage for performing imaging is substantially stable. Image processor 15 automatically processes data representing multiple temporally sequential individual images of a portion of patient anatomy to identify first and second images. The first image comprises an image in the multiple temporally sequential individual images determined in response to the received signal. The second image is substantially exclusive of an indication of presence of a contrast agent successively followed by an image indicating presence of a contrast agent and is identified by comparing a difference between measures representative of luminance content of the second image and the image indicating presence of a contrast agent, with a threshold.

Image processor 15 also identifies a set of images comprising the first and second images and any sequential intervening images. Image data processor 29 automatically determines data representing an averaged image of the set of images for use as a mask image by employing an averaging function to average data representing multiple images of the set of images. User interface 26 presents processed image data comprising a DSA sequence for display while the patient is undergoing a medical procedure (or as a post-processing operation after a procedure is performed). As used herein an interventional device comprises a stent or a catheter, for example.

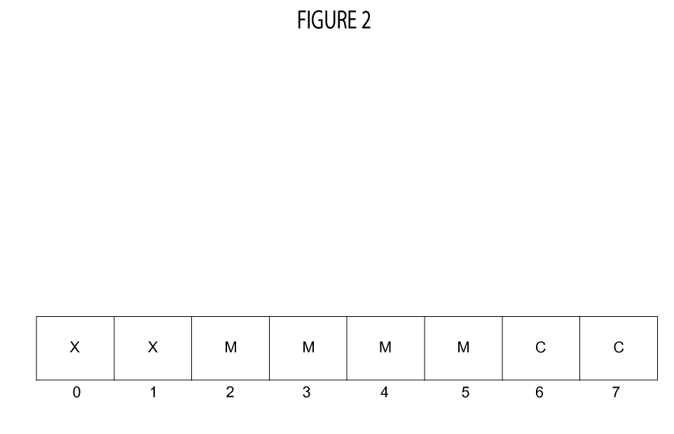

FIG. 2 illustrates an image sequence used for mask determination and generating a DSA image sequence. Frames 0 and 1, labelled with an X, are acquired before an X-ray radiation imaging dose has been regulated, i.e., is at a substantially stable level. Frames 0 and 1 are not viable mask frames. Frames 2 through 5 comprise a set of frames, labelled M, that are usable as candidate set of frames that are averaged to produce a mask frame, as the X-ray dose has been regulated and is substantially stable during the acquisition of these frames. Interface 36 receives a signal from an X-ray generator in X-ray imaging device 25 indicating X-ray radiation dosage for performing imaging is substantially stable and that frame 2 is a candidate for the candidate set of mask frames. Frame 6 is the first frame in which contrast media (C) is detected, and is excluded from the set of frames used for mask frame generation.

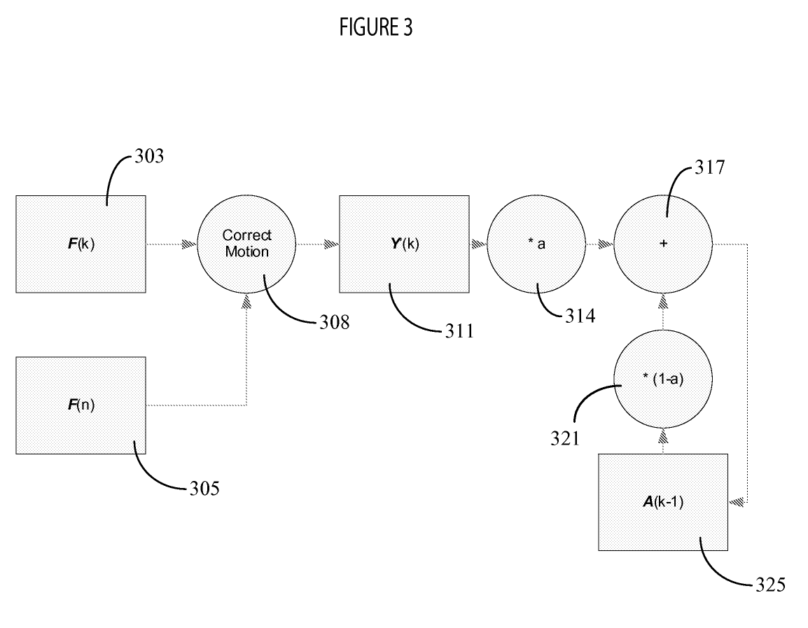

FIG. 3 shows a system for processing image data to provide an averaged mask built with recursive averaging and motion correction employed by image data processor 29. In this case, the motion between successive frames Fₖ 303 and Fₙ 305, for example, is corrected by unit 308 by automatically mutually aligning the frames to correct for displacement of features between the images to generate a frame Yₖ 311. Data representing frame Yₖ 311 is weighted by a by unit 314 and added by unit 317 to a current averaged frame Aₖ₋₁ 325 which is weighted by (1−a) in unit 321 via unit 317, where 0<a<1. The averaged mask frame in one embodiment comprises multiple frames identified as candidate mask frames, in different combinations. System 10 in different embodiments employs different ways to calculate an averaged mask frame, including, in one embodiment arithmetic averaging of each pixel luminance value across the candidate set of mask image frames and in another embodiment using recursive averaging by employing an IIR (infinite impulse response) filter, where the average Aₖ of frames n through n+k is defined as aFₙ+(1−a)Aₖ₋₁, where a is between 0 and 1 as shown in FIG. 3.

Alternatively, another weighted average may be used involving assigning different image frames different weights in deriving a computed average. For example, the most recent frames may be given progressively more weight. In addition to averaging image frames, motion detected between successive mask frames is corrected in mask images of a candidate set of mask images before deriving an averaged mask. This reduces the likelihood of anatomy in the mask being blurred by motion artefacts during averaging.

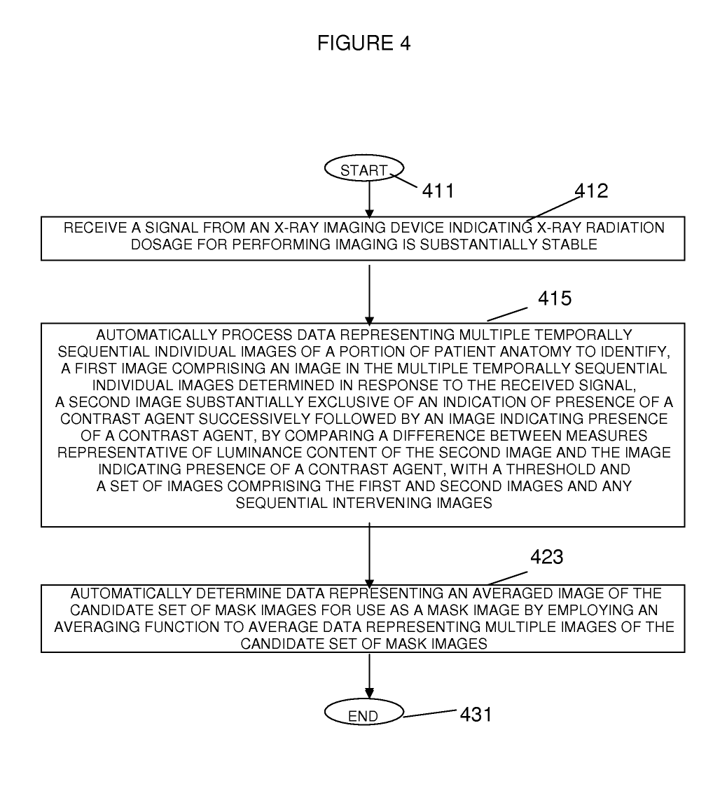

FIG. 4 shows a flowchart of a process used by system 10 for generating a mask image representing background medical image detail for use in X-ray imaging. In step 412 following the start at step 411, interface 36 receives a signal from X-ray imaging device 25 indicating X-ray radiation dosage for performing imaging is substantially stable in response to a determination at least one of, (a) electrical power and (b) electrical current, used by an X-ray emitter device is substantially stable. In step 415 image processor 15 automatically processes data representing multiple temporally sequential individual images of a portion of patient anatomy to identify a candidate set of mask images between a first image acquired when X-ray radiation dosage is substantially stable during acquisition of the sequential individual images and a second image comprising a last image substantially exclusive of an indication of presence of a contrast agent in the sequential individual images.

Image processor 15 identifies the first image as a first complete image following the received signal indicating radiation dosage for performing imaging is substantially stable. Image processor 15 identifies the second image as being successively followed by an image indicating presence of a contrast agent and substantially immediately preceding the image indicating presence of a contrast agent, by comparing a difference between measures representative of luminance content of the second image and the image indicating presence of a contrast agent, with a threshold. Image processor 15 derives measures representative of luminance content of the second image and the image indicating presence of a contrast agent using at least one of multiple different processes including using a histogram derived from pixel grayscale values, for example.

Image data processor 29 in step 423 automatically determines data representing an averaged image of the candidate set of mask images for use as a mask image by employing an averaging function to average data representing multiple images of the candidate set of mask images. The candidate set of mask images comprises the first and second images and any sequential intervening images. The averaging function comprises at least one of, (a) arithmetic averaging, (b) recursive averaging, (c) recursive averaging including motion compensation and (d) weighted averaging, of individual pixels in the multiple images of the candidate set of mask images. The weighted averaging function provides a weighted average by individually weighting individual images of the candidate set of mask images. Image data processor 29 subtracts data representing the mask image from data representing images of the temporally sequential individual images to remove background image detail and emphasize vessel structure in providing processed image data for display via user interface 26. Image data processor 29 dynamically substitutes the mask image for a previously used mask image. The process of FIG. 4 terminates at step 431.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A display processor or generator is a known element comprising electronic circuitry or software or a combination of both for generating display images or portions thereof.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-4 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system automatically generates a mask frame comprising an average of a set of image frames preceding a first frame of a sequence containing contrast agent, for use in deriving a digital subtraction angiography (DSA) image sequence. Further, the processes and applications may, in alternative embodiments, be located on one or more (e.g., distributed) processing devices on a network connecting the elements of FIG. 1. Any of the functions and steps provided in FIGS. 1-4 may be implemented in hardware, software or a combination of both.

What is claimed is:

1. A system for generating a mask image representing background medical image detail for use in X-ray imaging, comprising:
an interface for receiving a signal from an X-ray imaging device indicating X-ray radiation dosage for performing imaging is substantially stable;
an image processor for automatically processing data representing a plurality of temporally sequential individual images of a portion of patient anatomy to identify,
a first image comprising an image in said plurality of temporally sequential individual images determined in response to the received signal,
a second image substantially exclusive of an indication of presence of a contrast agent successively followed by an image indicating presence of a contrast agent, by comparing a difference between measures representative of luminance content of the second image and said image indicating presence of a contrast agent, with a threshold and
a set of images comprising the first and second images and any sequential intervening images; and
an image data processor for automatically determining data representing an averaged image of said set of images for use as a mask image by employing an averaging function to average data representing a plurality of images of said set of images.

2. A system according to claim 1, wherein
said image data processor subtracts data representing said mask image from data representing images of said temporally sequential individual images to remove background image detail and emphasize vessel structure in providing processed image data for display.

3. A system according to claim 2, including
a user interface displaying said processed image data.

4. A system according to claim 1, wherein
said signal from said X-ray imaging device indicates X-ray radiation dosage for performing imaging is substantially stable in response to a determination at least one of, (a) electrical power and (b) electrical current, used by an X-ray emitter device is substantially stable.

5. A system according to claim 1, wherein
said image processor identifies said first image as a first complete image following said received signal indicating radiation dosage for performing imaging is substantially stable.

6. A system according to claim 1, wherein
said averaging function comprises arithmetic averaging of individual pixels in the plurality of images of said set of images.

7. A system according to claim 1, wherein
said averaging function comprises recursive averaging.

8. A system according to claim 1, wherein
said averaging function comprises recursive averaging including motion compensation.

9. A system according to claim 1, wherein
said second image substantially immediately precedes said image indicating presence of a contrast agent.

10. A system according to claim 1, wherein
said image data processor dynamically substitutes said mask image for a previously used mask image.

11. A system according to claim 1, wherein
said image processor derives measures representative of luminance content of the second image and said image indicating presence of a contrast agent using at least one of a plurality of different processes.

12. A system according to claim 11, wherein
said at least one of said plurality of different processes comprises a histogram derived from pixel grayscale values.

13. A system according to claim 1, wherein
said averaging function is a weighted averaging function.

14. A system according to claim 13, wherein
said weighted averaging function provides a weighted average by individually weighting individual images of said set of images.

15. A system for generating a mask image representing background medical image detail for use in X-ray imaging, comprising:
an interface for receiving a signal from an X-ray imaging device indicating X-ray radiation dosage for performing imaging is substantially stable in response to a determination at least one of, (a) electrical power and (b) electrical current, used by an X-ray emitter device is substantially stable;
an image processor for automatically processing data representing a plurality of temporally sequential individual images of a portion of patient anatomy to identify a candidate set of mask images between a first image acquired when X-ray radiation dosage is substantially stable during acquisition of the sequential individual images and a second image comprising a last image substantially exclusive of an indication of presence of a contrast agent in the sequential individual images; and
an image data processor for automatically determining data representing an averaged image of said candidate set of mask images for use as a mask image by employing an averaging function to average data representing a plurality of images of said candidate set of mask images.

16. A system according to claim 15, wherein
said image processor identifies said second image as being successively followed by an image indicating presence of a contrast agent, by comparing a difference between measures representative of luminance content of the second image and said image indicating presence of a contrast agent, with a threshold and
said candidate set of mask images comprises the first and second images and any sequential intervening images.

17. A method for generating a mask image representing background medical image detail for use in X-ray imaging, comprising the activities of:
receiving a signal from an X-ray imaging device indicating X-ray radiation dosage for performing imaging is substantially stable in response to a determination at least one of, (a) electrical power and (b) electrical current, used by an X-ray emitter device is substantially stable;
automatically processing data representing a plurality of temporally sequential individual images of a portion of patient anatomy to identify a candidate set of mask images between a first image acquired when X-ray radiation dosage is substantially stable during acquisition of the sequential individual images and a second image comprising a last image substantially exclusive of an indication of presence of a contrast agent in the sequential individual images; and
automatically determining data representing an averaged image of said candidate set of mask images for use as a mask image by employing an averaging function to average data representing a plurality of images of said candidate set of mask images.

18. A method according to claim 17, wherein
said averaging function comprises at least one of, (a) recursive arithmetic averaging of individual pixels in the plurality of images of said set of mask images, (b) recursive weighted averaging and (c) a recursive weighted average of individually weighted individual images of said set of mask images.
